(19) United States
(12) Patent Application Publication
(10) Pub. No.: US 2002/0049910 A1
(43) Pub. Date: Apr. 25, 2002

(54) Unified trust model providing secure identification, authentication and validation of physical products and entities, and processing, storage and exchange of information

(76) Inventors: Allen Michael Salomon, Fairfield, CA (US); Roland Francis Trinka, Petaluma, CA (US)

Correspondence Address: Hickman Palermo Truong & Becker, LLP, 1600 Willow Street, San Jose, CA, 95125-5106, US

(21) Appl. No.: 09/916,139

(22) Filed: Jul. 25, 2001

Related U.S. Application Data
(60) Provisional application No. 60/221,221, filed on Jul. 25, 2000.
(60) Provisional application No. 60/254,814, filed on Dec. 11, 2000.
(60) Provisional application No. 60/264,368, filed on Jan. 25, 2001.
(60) Provisional application No. 60/264,298, filed on Jan. 25, 2001.
(60) Provisional application No. 60/265,457, filed on Jan. 30, 2001.

(51) Int. Cl. H04L 9/32

(52) U.S. Cl. 713/193

(57) ABSTRACT

A security infrastructure is described that enables a highly secure, dynamic, robust, and extensible security infrastructure. The security infrastructure uses integrated circuits (TEIs) that generate a unique set of output values in response to receiving a given set of “input seed values”. The particular output values generated by a TEI in response to input seed values cannot, for all practical purposes, be predicted. “Trusted Objects” (TOs) are data structures that are encrypted using keys generated from the unique set of output values generated by one or more TEIs in response to input seed values applied to those TEIs. The keys are formed using a key generation process that computes keys from the TEI output values. Thus, the keys may be regenerated by later applying the same input seed values to the TEIs, and applying the resultant output values to the key generation process to reproduce the original keys.

### RELATED APPLICATIONS

This application claims priority to “Techniques and Systems for Identifying, Tracking and Securing Items”, U.S. Provisional Application No. 60/221,221, filed by Allen Michael Salomon and Roland Francis Trinka on Jul. 25, 2000, herein '221, the contents of which are incorporated by reference as originally set forth herein.

This application claims priority to “Establishing And Authenticating The Unique Identity Of a Product Or Entity Marking Identifier Using An Externally Seeded Multidimensional Number Generator”, U.S. Provisional Application No. 60/254,814, filed by Allen Michael Salomon and Roland Francis Trinka on Dec. 11, 2000, herein '814, the contents of which are incorporated by reference as originally set forth herein.

This application claims priority to “Cryptographic Key Generation Using Behavior Seed Data Inputs”, U.S. Provisional Application No. 60/264,368, filed by Allen Michael Salomon and Roland Francis Trinka on Jan. 25, 2001, herein '368, the contents of which are incorporated by reference as originally set forth herein.

This application claims priority to “Relationship Locking In A Kernel Trust Architecture Supporting Electronic Identifiers Used To Establish The Unique Identities”, U.S. Provisional Application No. 60/264,298, filed by Allen Michael Salomon and Roland Francis Trinka on Jan. 25, 2001, herein '298, the contents of which are incorporated by reference as originally set forth herein.

This application claims priority to “Method Of Secure Data Communications Between Electronic Devices Based On Unique Device Identification Data And Mathematically Related Delta Seed And Methodology Values”, U.S. Provisional Application No. 60/265,457, filed by Allen Michael Salomon and Roland Francis Trinka on Jan. 30, 2001, herein '457, the contents of which are incorporated by reference as originally set forth herein.

This application is related to “Relational Trust Model Used to Establish Secure Information Exchange Channels Between Multiple Clients Based on Distributed Chain-Of-Trust Association”, Attorney Docket No. 54308-0022, filed by Allen Michael Salomon and Roland Francis Trinka on the equal day herewith, herein the “Chains-of-Trust”, the contents of which are incorporated by reference as originally set forth herein.

This application is related to “Hierarchical Information Exchange Model Used to Establish Secure Information Exchange Channels Between Multiple Clients in a Defined Relational Group”, Attorney Docket No. 54308-0021, filed by Allen Michael Salomon and Roland Francis Trinka on the equal day herewith, the contents of which are incorporated by reference as originally set forth herein.

This application is related to “Container Used For the Highly Secure and Manageable Transportation of Physical Goods”, Attorney Docket No. 54308-0023, filed by Allen Michael Salomon and Roland Francis Trinka on the equal day herewith, the contents of which are incorporated by reference as originally set forth herein.

This application is related to “Preventing External Energy Field Detecting Devices from Reading the Program Logic Transitions Occurring In Digital Microprocessor IC chips”, Attorney Docket No. 54308-0024, filed by Allen Michael Salomon and Roland Francis Trinka on the equal day herewith, the contents of which are incorporated by reference as originally set forth herein.

This application is related to “Flexible Architecture for the Highly Secure and Manageable Distribution of Digital Audio and Video Media Files”, Attorney Docket No. 54308-0025, filed by Allen Michael Salomon and Roland Francis Trinka on the equal day herewith, the contents of which are incorporated by reference as originally set forth herein.

### FIELD OF THE INVENTION

The present invention relates to computer and electronic security systems, and in particular, to protocols and devices for authenticating and validating the unique identities of a wide range of physical entities, and for cryptographically securing data structures and communications channels associated with the physical entities' usage and application.

### BACKGROUND OF THE INVENTION

Cryptographic based technology is widely used to identify and authenticate data entities. Cryptographic-based technology is varied and inherently complex. The Public Key Infrastructure is one of the most widely cryptographic-based technologies in use. The Public Key Infrastructure involves the use of asymmetric cryptography and public and private asymmetric key pairs to generate and validate digital IDs and electronic signatures.

Conventional approaches that identify and authenticate entities using digital certificates are tied to validating digital certificates presented by the entities. Typically, these approaches rely on third parties to verify an entity's identity based on digital certificates, to sign and issue digital certificates to those entities, and validate the certificates' ongoing trustworthiness after issuance. Examples of trusted third parties, include Certificate Authorities, Registration Authorities, and Validation Authorities. The trust model upon which the issuance of digital certificates is based assumes a hierarchical chain of public Certified Authorities, Registration Authorities, and Validation Authorities, none of which has any verifiable physical or virtual trusted relationship with the certificates' issuee.

Digital certificates and associated private keys are inherently difficult to protect from copying, cloning, and forging. Certificates and associated private keys are data files, which are freely transferable. In addition, any entity that may copy the key and the digital certificate usurps the identity and authority of the entity for which the digital certificate was intended. Therefore, digital certificates and asymmetric keys are not well suited where they may be exposed and easily copied.

There is currently no way to directly ascertain the digital certificates' and asymmetric key pairs' validity by simply examining certificates and keys themselves, because there is no correlation between the certificates' and keys' issuance and their ongoing trustworthiness. The certificate issuers have no direct access to the certificates and keys or control over their use once issued, and thus cannot directly invalidate the certificates and keys or any copies of them directly.

One solution to this problem is to establish electronic lists of known compromised or revoked certificates. These lists are called Certificate Revocation Lists, and are maintained by the certificate and key issuers. Those using a digital certificate and key to authenticate a presenter of the digital certificate and key must communicate a request, typically over a network, to an issuer to determine whether a digital certificate and key are still valid. Obviously communication over a network may cause an undesirable amount of overhead and inefficiency.

Furthermore, there is also no universal standard used by certificate issuers for the process of determining the validity of digital certificates. To use digital certificates of different issuers requires implementation of a different process to determine the validity of digital certificates.

It is also very impractical to distribute new digital certificates and keys to the existing certificate holders should a certificate be compromised. If the Certificate Authority with millions of issued digital certificate and keys had to revoke all those certificates and keys and reissue replacements, new certificates and keys would have to be issued to each of the million holders. The resulting Certificate Revocation List would be huge, further complicating and slowing down the digital certificate validation process in all future transactions involving digital certificates issued by that CA.

Another approach used to identify and authenticate involves the use of electronic circuit devices referred to herein as electronic identifier devices. These devices have been used to identify, for example, physical products and/or entities. Examples include Smart Cards and RFID-based vehicle identifiers for automated bridge toll collection.

One problem with these electronic circuit devices is the lack of a uniform model or infrastructure which provides the framework for disparate technologies and applications to operate with each other and the associated real-world applications. Another problem with the electronic identifier devices is that they are identified and authenticated using digital values stored within them. The digital values can be stolen and used by unauthorized persons.

Based on the foregoing, there is clearly a need to provide an uniformed approach for identifying, authenticating, and validating entities that cannot be compromised by stealing data and information presented by those entities for the purpose of being identified and authenticated.

### SUMMARY OF THE INVENTION

A security infrastructure is described that enables a highly secure, dynamic, robust, and extensible security infrastructure. The security infrastructure is very flexible and may be extended to numerous applications, from network security, for both private and public networks, to product authentication, including the authentication of digital media products and other types of physical products. According to an aspect of the present invention, the security infrastructure uses integrated circuits (TEIs) that generate a unique set of output values in response to receiving a given set of “input seed values”. The particular output values generated by a TEI in response to input seed values cannot, for all practical purposes, be predicted. The TEIs are constructed and incorporated into a physical entity in such a way that they may not be emulated or forged. “Trusted Objects” (TOs) are data structures that are encrypted using keys generated from the unique set of output values generated by one or more TEIs in response to input seed values applied to those TEIs. The keys are formed using a key generation process that computes keys from the TEI output values. Thus, the keys may be regenerated by later applying the same input seed values to the TEIs, and applying the resultant output values to the key generation process to reproduce the original keys.

The original keys do not have to be stored, where they may be later copied and used for purposes of breaching security. Instead, only the input seed values need be stored, to be later applied to the applicable TEIs to decrypt the TO. Since the output values generated by a given TEI are unique relative to the stored input seed values and cannot be predicted based on knowledge of the input seed values, it is assumed that only the TEIs whose output values were used to generate the original keys can later supply the output values needed to regenerate the original keys and successfully decrypt the TO.

TOs and TEIs are powerful and versatile entities for cryptographically securing data. According to another aspect of the present invention, the Trusted Objects are data structures or objects that are created for a particular TEI to later authenticate an attribute of the TEI or the TEI's usage and application, such as its identity or its ownership. Among the types of information that can be encrypted based on the TEI's internal functions are product identifiers and ownership information. In addition, the key generation process may compute keys from the output values of multiple TEIs. Successful decryption of a TO is thus tied to the participation of the original TEIs used to generate the original keys.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates an integrated circuit used as a Trusted Entity Identifier according to an embodiment of the present invention;

FIG. 2 is a functional block diagram illustrating a preferred Analog Personality Matrix according to an embodiment of the present invention;

FIG. 3 is a block diagram that illustrates micro level and macro level components of a Kernel Trust Architecture, an architecture for the Uniform Trust Model according to an embodiment of the present invention;

FIG. 4 is an illustration of example Root Data Trusted Objects and Virtual Usage Trusted Objects according to an embodiment of the present invention;

FIG. 5 is a block diagram of an example closed (private) implementation of the uniform trust module according to an embodiment of the present invention; and

FIG. 6 is a relational diagram illustrating another application of the Uniform Trust Model according to an embodiment of the present invention.

### DETAILED DESCRIPTION OF THE INVENTION

A method and apparatus for identifying, authenticating, and validating parties is described. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Uniform Trust Model Overview

The UTM encompasses numerous hardware and software components, design attributes and capabilities, the combined purpose of which is to provide a highly secure, dynamic, robust and extensible trust infrastructure. The UTM is based on the use of Trusted Entity Identifiers (TEIs).

TEIs are integrated circuits that generate a unique set of output values in response to receiving a given set of “input seed values”. Specifically, TEIs respond to a given set of input seed values by generating a unique set of output values that are unique relative to the output values generated by other TEIs for the same given set of input seed values. TEIs are capable of generating output values that are unique in this way in response to numerous permutations of input seed values. Because the TEI can generate a set of output values that are unique in this way for numerous sets of input values, the unique output values are referred to herein as being multidimensional.

The term “unique”, as used herein, does not require “uniqueness” in its absolute sense. Instead, the term is used to denote that the probability of a set of output values being replicated by two or more TEIs in response to the same set of input values is so low that, for purposes of security, it may be assumed that only one TEI can produce the set of output values in response to the set of input seed values. The probability may vary according to security needs and protocol requirements.

TEIs may be physically incorporated within entities and used to authenticate various aspects of these entities. Examples of various aspects that can be authenticated include identity and ownership. TEIs are incorporated into entities in such a way that if they are removed or tampered with they will no longer generate the same set of unique output values. In fact, they may even no longer operate. The term incorporating refers to, without limitation, embedding a TEI into the structure of an entity or attaching the TEI to the structure of an entity.

UTM uses Trusted Objects (TO) to authenticate TEIs. A TO is a data structure or object that is created for a particular TEI, and which contains information that is cryptographically secured and can be used to later authenticate the TEI. Each TO is created using a protocol that generates cryptographic keys used to sign/encrypt the data contained within the Trusted Object. The cryptographic keys are computed by applying the unique output values that are generated by one or more specific TEIs in response to receiving a particular set of input seed values. The TOs, and the TEIs, input seed values, and output values used to generate the TO, are referred to herein as being bounded to each other. The input seed values are also referred to herein as being the TO's input seed values. A TO may be bound to multiple TEIs, and may have multiple sets of input seed values (i.e. different sets of input seed values applied to different TEIs).

A TO is associated with the input seed values used to create the TO. These input seed values are used by a process that may follow a variety of protocols to authenticate TEIs. Such protocols depend on the principle that, in response to receiving a TO's applicable input seed values, only the TEI bound to the TO can generate the unique output values that are bounded to the TO. The TO contains data used by the protocols to determine whether the given set of output values are the ones that would be produced by the authentic TEI.

The contents of a Trusted Object depend on the protocol (or protocols) used to generate and authenticate the TEI to which the Trusted Object is bound. The present invention is not limited to any particular content, logically or physically, or to any protocol.

For the purposes of illustration, a Trusted Object is generated and authenticated according to the following illustrative protocol. A manufacturer of a product embeds a TEI in the product. The manufacturer uses a unique identifier value to identify the product. TEI A transmits a set of input seed values to TEI B. TEI B receives the input seed values and generates unique output values and transmits them to TEI A. TEI A then uses the received output values as input seed values to itself, and generates another set of output values. This set of output values are used as keys to encrypt the identifier. The unique identifier and its encrypted version are stored in the TO.

TEI A stores data linking the input seed values to TEI B and the TO, thereby associating the TO with the input seed values and TEI B.

The TEI may then use the Trusted Object to authenticate a TEI purporting to be TEI B. Specifically, the purporting TEI presents the unique identifier identifying TEI B to TEI A. TEI A retrieves the TO containing the unique identifier identifying TEl B. TEI A transmits the input seed values associated with TEI B to the purporting TEI, which receives the input seed values, generates intermediate output values, and transmits them to TEI A. TEI A then uses the received intermediate output values as input seed values to itself, and generates another set of output values. These output values are used as keys to decrypt the encrypted data in the TO. If the decrypted data matches the unique identifier, then TEI B is considered authentic.

Note that in this illustration the TO is bound to both TEI A and TEI B, because, in part, the output values of both were used to generate the TO. The UTM, however, does not require a TO be bound to more than one TEI.

For example, rather than TEI A using the intermediate output values returned by the purporting TEI as input seed strings to itself to generate other output values, the intermediate output values may be used directly to generate the key (or keys) to encrypt the TO identifying TEI B. The encrypted data is stored in the TO. Later, a TEI purporting to be TEI B presents the identifier to TEI A. TEI A retrieves the TO having the identifier value, transmits the TOs input seed string to the purporting TEI, and receives output values from the purporting TEI. These output values are used to generate the key (or keys) to decrypt the encrypted identifier in the TO. If the decrypted data matches the identifier, then the purporting identifier is authentic.

TEIs are described herein as being authenticated and validated. However, this is just a way of conveniently expressing that the entity which a TEI is attached to or embedded within is being authenticated and validated, or expressing that both the TEI and entity are being authenticated. Furthermore, many actions described as being performed by a TEI may in fact be performed by entities to which the TEI is embedded or attached. For example, a “TEI transmitting input values” is just a convenient way of expressing that a device (e.g. computer, computer card) to which the TEI is attached is transmitting the input values.

### Terminology and Concepts

The following terminology is used to describe various aspects of the components, elements, and processes that are part of the UTM.

Trusted Entities are entities that are capable of being deemed authentic using a TEI incorporated into the entity and one or more TOs established for the TEI for the purpose of authenticating the TEI. A Trusted Entity is established as a Trusted Entity when the TO is created to authenticate an attribute related to the TEI.

An Analog Personality Matrix (APM) is a mechanism in an electronic integrated circuit (TEI) that generates a large set of unique output string values. These output string values depend on internal sampling of inherent and/or intentionally induced anomalies of the APM's physical/electrical structure and upon the affect that the external seed string values have upon the value of the output strings generated by the sampling processes.

The CryptoPrint Process (CPP) is a process which incorporates APMs and cryptographic and mathematical processes within the TEI to produce unique output values. These cryptographic and mathematical processes, which are affected by “delta offset” input values and mathematical behavior input values, are applied to the APM's numeric output string values. The resulting TEI output values are referred to herein as CPP values.

The CryptoPrint Objects (CPO) contain input seed strings, a delta “offset”, and a mathematical behavior value. These values are used as input seed values to authenticate a TEI according to a particular protocol. A CPO may contain other data which is used to authenticate a TEI, as shall be described in greater detail. A CPO may also be a form of TO, signed by and bound to, for example, the Trusted Entity on which the CPO is stored.

Validity Objects (VO) contain (logically or physically) reference to one or more CPOs and their relationship to a TO. A TO is linked to at least one VO; thus a VO links a TO to CPOs that may be used to decrypt the TO. VOs may be TOs themselves, signed by and bound to, for example, the Trusted Entity on which the VO is stored. A VO may also contain data indicating the validity status of a TO. Thus, if a TO needs to be invalidated, the VO may be updated to reflect the invalidity of the TO. Thus, information indicating the validity of the TO may be stored separately from the TO itself.

The Universal Product Identity (UPID) is a numeric value that uniquely identifies a TEI and which refers to a TO used to authenticate the identity of a TEI purporting to be the TEI identified by the numeric value. Typically, the UPID numeric value is a value assigned to a TEI by a trust authority, where the value is unique relative to other numbers assigned by that authority to other TEIs. An example of a UPID and an authority that assigns a UPID is a manufacturer of products that embeds TEIs into the products, and assigns a number value to each product embedded with a TEI. The number assigned is unique relative to other numbers assigned to the products by the manufacturer.

The Universal Trusted Identity (UTID) is a numeric value that identifies some attribute related to a TEI, and refers to a TO related to that attribute. These TOs can be used to authenticate whether TEIs that purport to have the attribute identified by the UTID actually have that attribute. An example of such an attribute is the ownership of a TEI.

A Universal Trust Constant (UTC) is a TO bound to a TEI and which is created for the purpose of allowing other Trusted Entities to subsequently authenticate the identity of the TEI. For example, a UTC may be created for a product so that subsequent shippers and buyers may authenticate the product. Typically, a UTC is established when a TEI is incorporated into an entity. The TOs associated with the UPID and UTID values of a TEI are thus UTCs for that TEI and the physical entity it is attached to or embedded within.

For example, a UTC may be bound to two TEIs—one TEI attached to a product, and another TEI attached to a device responsible for creating and storing UTCs for This attached to products manufactured by a particular company. The device acts as an authenticating authority for the identity of products manufactured by the particular company. Requests to authenticate a particular TEI are transmitted to the authenticating authority. The authenticating authority accesses the UTC for the particular TEI and interacts with the TEI through secure channels to authenticate the TEI.

Because the UTC is bound to the device, its CPP generated output is needed to authenticate the TEI. However, it is not necessary to bind a UTC to more TEIs than the one for which the UTC is established. For example, a UTC may be created using a TEI's CPP values as encryption keys, as illustrated before. Such a UTC can be transmitted to other Trusted Entities who may themselves authenticate a TEI using the UTC.

A Trusted Relationship (TR) is the relationship between two or more Trusted Entities that exists when they are able to authenticate each other's identities through processes bound to their TEI/CPP output values.

The Kernel Trust Architecture defines a number of functions and services applicable in support of the UTM and its' underlying hardware and software components.

### Illustrative Embodiment

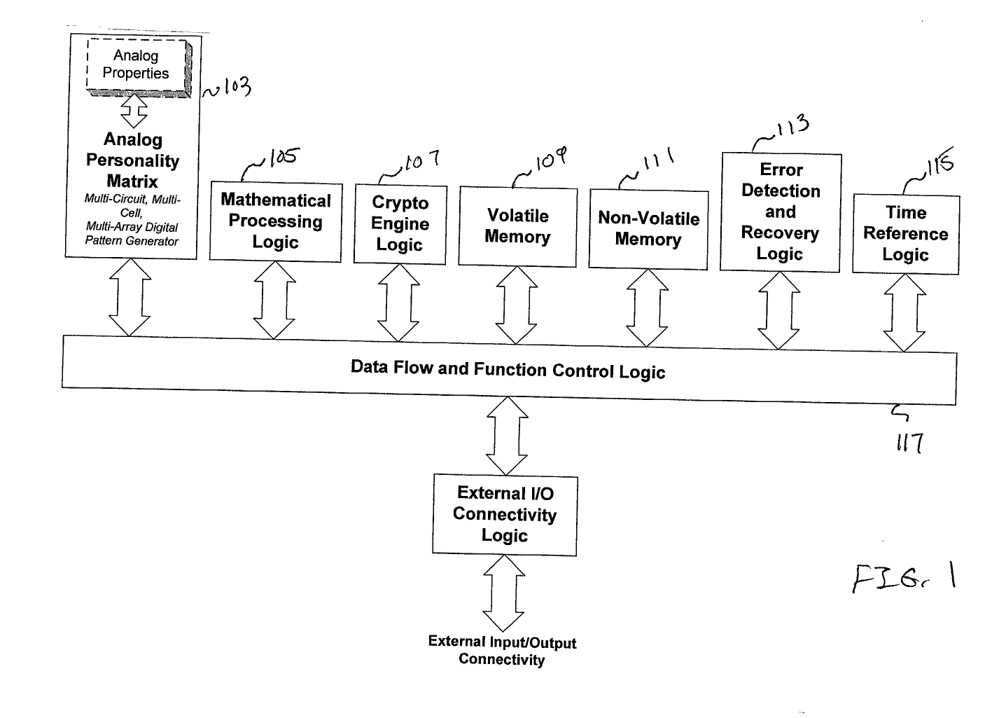

The UTM is based on the security, trust and information management capabilities provided by TEIs, which are attached to physical products and entities. FIG. 1 shows an overall architecture and design of a TEI according to an embodiment of the present invention. Referring to FIG. 1, it shows components for TEI 101, as follows.

APM 103, a multidimensional digital pattern generator. Examples of APMs are covered in the '894. Design parameters such as the input seed string set's size, the definition and number of input seed string sources, the output string set's size, the structure, materials, and fabrication methods of the APM's analog properties and anomalies, and the sampling circuit, cell, and array matrix sizes, configuration and methodologies, may be determined based on the requirements of the TEI's application.

Mathematical processing logic 105. Design parameters such as the number and type of mathematical operations supported and size of numeric values handled are based on the requirements of the TEI's application.

Crypto Engine Logic 107. Design parameters such as the cryptographic encryption and decryption algorithms supported, size of numeric inputs, output and key values are determined based on the requirements of the TEI's application.

Volatile memory 109 and non-volatile memory 111. Volatile memory 109 and nonvolatile memory 111 are used to store temporary and/or permanent binary values. Design parameters such as the number and type of memory storage locations and number of bits in each location are determined based on the requirements of the TEI's application.

Error detection and recovery logic 113. Used to detect and/or correct bit errors in the APM's output string values and/or the contents of volatile and non-volatile memory. Design parameters such as the number of bits detectable and correctable and detection and correction methodologies are based on the requirements of the TEI's application.

Time reference logic 115. Design parameters such as the time reference's accuracy and source (internal or external clock) are determined based on the trust and security requirements of the TEI's application.

Data flow and function control logic 117. Used to coordinate the interoperations of all internal processing and storage functions and external input and output connections. Design parameters such as the data and/or control path width(s) and configuration are determined based on the requirements of the TEI's application.

External input/output connectivity logic 119. Design parameters such as the number and/or types of input/output paths (direct-wired, infrared, radio frequency, etc.) are determined based on the requirements of the TEI's application.

An APM can produce a very large unique set of numeric output strings whose values are determined by:

Unique analog properties and anomalies of the APM's internal structure, which are sampled and logically and mathematically processed by the APM.

Numeric input seed string values that influence the APM's sampling processes.

Thus an APM's numeric output string values are relationally bound to a specific combination of the APM's unique internal analog properties and anomalies and the input seed string values applied to the APM. A TEI is designed such that an APM's analog property and anomaly values are only accessible and measurable within the APM, and any external attempt to access or measure an APM's analog property or anomaly values permanently alters and destroys those values, thus rendering the TEI functionally inoperative and detectable as having been compromised.

### Detailed Illustrative Implementation of a TEI

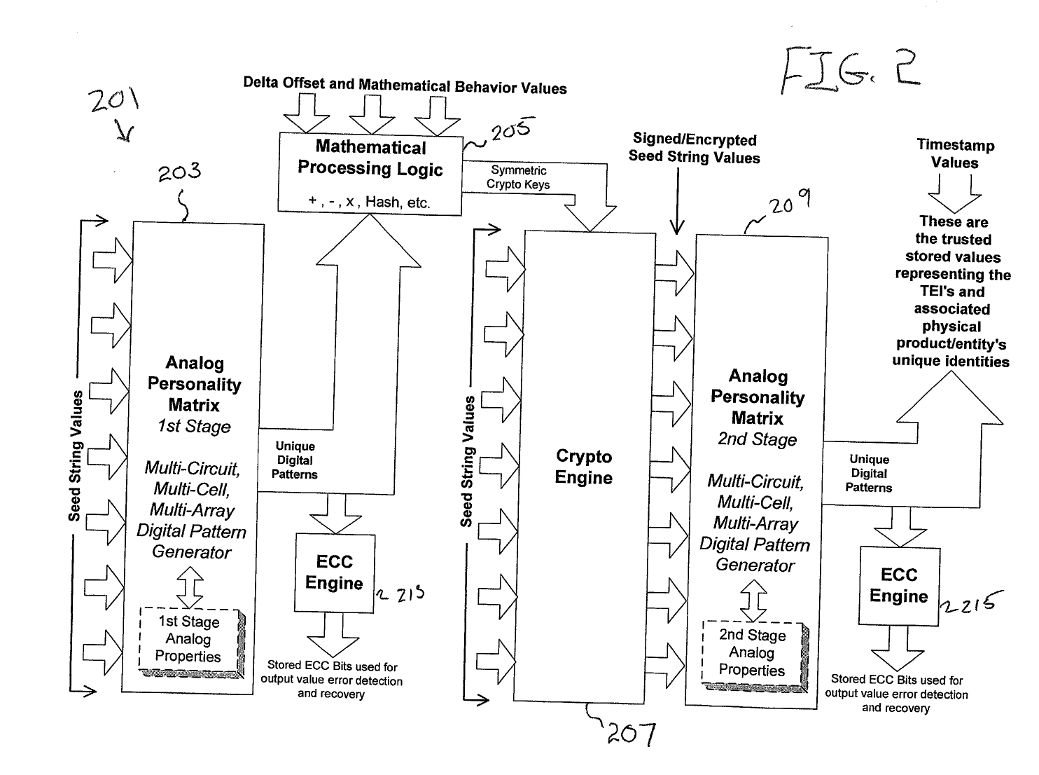

FIG. 2 is a block diagram depicting various TEI components that participate in a CryptoPrint process (CPP) according to an embodiment of the present invention. The process includes 2 stages in which an APM generates unique digital patterns in response to receiving input seed string values. Referring to FIG. 2, TEI architecture 201 includes APM 203, which performs the first stage, receives numeric input seed string values and generates as output unique numeric string values. These values are sent as input to the Mathematical Processing Logic 205, where the values are mathematically manipulated based on the application of delta offset and mathematical behavior values. For example, if the APM output string value is 235631, the delta offset value is 300, and a mathematical behavior value specifies that subtraction operations are applied by the Mathematical Processing Logic 205, the resulting value will be 235331. The output value of Mathematical Processing Logic 205 is then applied as a symmetric cryptographic key to Crypto Engine 207, which uses the key to sign and encrypt the same seed string values as were input to the APM 203.

At the commencement of the second stage, APM 209 receives the signed numeric seed string values from the Crypto Engine 207 and outputs corresponding unique numeric string values. APM 209 generates output string values. The output string values may be defined as CPP output values and stored along with time stamp values. CPP output values are thus bound both physically and logically to the TEI's unique CPP-based identity and to the corresponding set of input seed string, delta offset and mathematical behavior values upon which they are based.

The output values from both stages are also processed through the Error Correction Circuitry (ECC) Engines 213 and 215, respectively. The ECC output bits are stored as referencing the associated seed string values, and used for error detection and recovery to enhance an APM's long-term reliability.

Each CPP output value and its' associated time stamp, seed string, delta offset and mathematical behavior values collectively form a set of data which virtually binds unique analog properties and anomalies of the TEI's internal structure to the specific source(s) from which the seed string, delta offset and/or mathematical behavior values are obtained, and the purposes those source data represent. This set of data is stored in a CPO.

The Kernel Trust Architecture, described later herein, includes micro and macro processes that leverage CPOs. CPOs are used to establish, authenticate, and validate the identities of TEIs' CPP-based identities and their associated physical products and entities, and bind those identities to related Trusted Object data values and structures (e.g. UTCs, UPIDs, UTIDs, UGTIDs, TOs, VOs, TRs).

CPP values can also be leveraged to securely bind other processes, data structures, and applications associated with TEIs' and physical entities' real-world usage to the TEIs' CPP-based identities. Examples include generating cryptographic keys and establishing secure data communications channels that are relationally bound both to the CPP-based identities of the TEIs and physical entities involved in a specific transaction and to the associated processes, data structures, and applications associated with that specific transaction.

The architecture of a TEI has been illustrated with two APMs. However, an embodiment that uses APMs is not limited to use of two APMs. For example, the configuration of TEI architecture 201 may be modified to incorporate a pair of APMs operating in parallel for purposes of redundancy and failure recovery. The output values of the parallel APMs are thus logically bound in common to the same input seed string values. If one of the parallel APMs becomes inoperative, the other APM(s) can still support the TEI's CPP capabilities. For example, a pair of parallel APMs includes an APM A for stage 1 and an APM B for stage 2. This configuration can produce four sets of complimentary time-stamped CPP output values (from combination APM 203 and APM 209 output strings, from combination APM A and APM B output strings, from combination APM 203 and APM B output strings, and from combination APM A and APM 209 output strings), as shown below:

Seed String Values>>Crypto Engine>>APM 209>>CPP Values

Seed String Values>>APM 203>>Mathematical Processing Logicˆ Time Stamp Valuesˆ

Seed String Values>>Crypto Engine>>APM B>>CPP Values

Seed String Values>>APM 203>>Mathematical Processing Logicˆ Time Stamp Valuesˆ

Seed String Values>>Crypto Engine>>APM B>>CPP Values

Seed String Values>>APM A>>Mathematical Processing Logicˆ Time Stamp Valuesˆ

Seed String Values>>Crypto Engine>>APM 209>>CPP Values

Seed String Values>>APM A>>Mathematical Processing Logicˆ Time Stamp Valuesˆ

This configuration allows the TEI to sustain CPP functionality in the event of operational failure of either one of the two parallel APMs in either one or both of the two APM stages.

TEIs can be fabricated as stand-alone, self-contained IC chip devices, or incorporated into other devices, such as multi-component circuit boards and as subsections of larger multi-function ICs. A TEI's basic components are readily available designs that can be implemented using “hardwired” logic circuitry and/or micro-program logic flows. The UTM provides considerable latitude in the design and implementation of a TEI's functional components, allowing a wide range of applications to be supported. Thus, the complexity and per-unit cost of a given TEI design and implementation can be matched to the security requirements and assessed value of its intended application.

Further examples and details of the TEI logic's functions in the context of establishing, authenticating, and validating the CPP-based identities of and bound trusted relationships between TEIs and entities are covered in '298. Further examples and details of a TEI logic's functions in the context of generating CPP-based cryptographic keys are covered in the '368. Further examples and details of the TEI logic's functions in the context of establishing secure CPP-based data communications channels are covered in '457.

### Application Classes

The UTM defines four general classes of applications, reflecting progressively higher trust and security benefits, values, complexities and implementation costs:

Class 1: Supports establishing, authenticating and validating the identities of the TEI, the TEI's manufacturer and issuer, the physical entity that the TEI is attached to or embedded within, and the physical entity's manufacturer and issuer. Example Class 1 applications include basic parts identification tags and electronic keys.

Class 2: Supports all Class 1 functions, plus establishing, authenticating and validating the physical entity's authorized owner, holder, or user. Examples of Class 2 applications include electronic ID cards, Smart Cards, and e-Wallets.

Class 3: Supports all Class 1 and 2 functions, plus establishing, authenticating and validating the rights associated with the physical entity's access and/or usage. Example Class 3 applications include Digital Rights Management, Hard and Soft Media distribution, and wireless device services.

Class 4: Supports all Class 1, 2, and 3 functions, plus establishing, authenticating and validating all other physical and virtual elements involved in the TEI and entity's transactional relationships with other TEIs and physical entities. Example Class 4 applications include B2B/B2C transactions, e-Signing and notarization, financial clearing, and supply chain management.

The design choices made for a given TEI implementation can be based on its' intended application and the relative trust and security requirements of the application's Class level. Specifically, simpler but less secure, reliable, and costly TEI designs and implementations are applied to lower Class level applications. More complex, secure, reliable, and costly TEI designs and implementations are applied to higher Class level applications.

The intended application(s) and relative trust and security requirements of an application's Class levels also affect the design and implementation complexities of the UTM infrastructure and associated hardware and software protocols and methodologies used to support those requirements. The UTM does not require a particular infrastructure of hardware and software protocols and methodologies used in the underlying components' design and implementation, allowing a wide range of latitude and flexibility in a particular implementation's costs and levels of trust and security provided.

Another consideration that can influence a UTM infrastructure's design and implementation is whether the underlying application operates in a closed (private), open (public) or hybrid (public/private) communications network. A UTM infrastructure's trust and security requirements, and its' complexity, are generally inversely proportional to the physical and virtual security controls available over which parties and entities are allowed to partake in networked data exchanges and the network medium through which those data exchanges are made. Closed and private network environments inherently offer greater physical and virtual security controls than open and public network environments, and so tend to require less complex UTM infrastructures, hardware and software protocols, and methodologies.

### Generating Trusted Objects that May Be Used to Authenticate

The following steps are an example protocol that allows an entity A and its' TEI to establish a Trusted Object representing the identity of Entity B's TEI.

1. Entity A assigns a UPID numeric value, referring to the unique identity of Entity B's TEI.

2. Entity A selects a numeric value, indicating one of the mathematical behavior functions, as mathematical behavior value M.

3. Entity A sends numeric value UPID as a seed string value, along with mathematical behavior value M, to Entity B.

4. Entity A generates and formats a random numeric value, such as the current time stamp, as delta offset value D.

5. Entity A sends delta offset value D to Entity B.

6. Entity B applies seed string value UPID, delta offset value D, and mathematical behavior value M as input to its' local TEI to generate an “intermediate” CPP output value.

7. Entity B sends the resultant CPP output value X as a seed string value to Entity A.

8. Entity A applies the intermediate seed string value, delta offset value D, and mathematical behavior value M as input to its' local TEI's CPP.

9. The resultant CPP output value C and associated delta offset value D, numeric value UPID and mathematical behavior value M are stored in a CPO.

10. Steps 4 through 9 are performed n times

11. The n CPOs are linked in a stored data structure defined as a VO representing the CPOs as a set, and the set's relationship to the protocol used to establish the identity of Entity B's TEI.

12. The VO is linked to a Trusted Object, which represents the trusted identity of Entity B's TEI.

13. The numeric value UPID is stored in the TO as referring to the trusted identity of Entity B's TEI and linking that identity to an external informational data structure associated with that identity.

14. The n intermediate CPP output values received from Entity B are used to generate an encryption key.

15. The encryption key is applied to cryptographically sign the TO.

Note that the pair of C, D values stored in each of the CPOs are bound to the unique analog properties and anomalies of both Entity A and Entity B's TEIs and APMs. In an infrastructure involving multiple entities, Entity A could apply this protocol to establish the identities of all other entities within the infrastructure, and be designated as a trusted authority for authenticating and validating those identities. The UPID and associated CPOs, VOs, and TOs could also be transferred to and stored on another TO server designated as a trust reference archive, thus separating the stored data structures from the only physical entity on which they have meaning. As mentioned earlier, the VO and CPOs may be stored as TOs themselves, bound to the TO servers' TEI.

Note that the intermediate CPP values generated by TEI B are not stored in the CPOs. Thus, the VO and CPOs do not reveal the data necessary to regenerate the key needed to decrypt the TO, nor is that data stored anywhere. The identity of Entity B's TEI as represented by the TO's contents is therefore inherently secure and trustworthy.

Entity B can use these same protocol steps (substituting ‘Entity B’ for ‘Entity A’, and ‘Entity A’ for ‘Entity B’) to establish and store the CPOs, VOs, and TOs representing the identity of Entity A's TEI.

### Authenticating Based on the Encrypted Data Stored in a Trusted Object

The following steps are an example protocol that allows Entity A and its' TEI to subsequently reference stored TO, VO, and CPOs to authenticate and validate the identity of Entity B's TEI. The protocol is based on decrypting the UPID or other reference data stored in a TO by regenerating a cryptographic key based on CPP output values produced by a specific TEI.

1. Entity A sends CPO 1's numeric value UPID as a seed string value, along with mathematical behavior value M, to Entity B.

2. Entity A sends CPO 1's delta offset value D to Entity B.

3. Entity B applies seed string value UPID, delta offset value D, and mathematical behavior value M as input to its local TEI's to generate an “intermediate” CPP output value.

4. Entity B sends intermediate CPP output value to Entity A.

5. Steps 2 through 4 are performed n times, incrementing the numeric references to the CPO [1, 2, 3 . . . n] in each iteration (one iteration for each of the CPOs/C, D value pairs in the TO set).

6. Entity A generates a cryptographic key based on the intermediate CPP output values received from Entity B.

7. Entity A applies the key to decrypt the TO and compares Entity B's UPID value with the unencrypted UPID value stored in the Trusted Object. If these values match, then entity B is authentic.

The authentication and validation processes described above are based on decrypting and examining the information stored in a Trusted Object. For processes that authentic and validate based solely on the ability to successfully decrypt data stored in Trusted Objects, it is not necessary to store CPP output values in CPOs such as was done for Entity A's TEI in the previous example protocol under GENERATING TRUSTED OBJECTS THAT MAY BE USED TO AUTHENTICATE.

### Authenticating Based on CPP Values Stored in a CPO

The following steps are an example protocol that allows Entity A and its' TEI to subsequently reference the stored TO, VO, and CPOs to authenticate and validate the identity of Entity B's TEI. Note that for purposes of security, the CPOs are stored as TOs bound to entity A.

1. Entity A sends CPO 1's numeric value UPID as a seed string value, along with mathematical behavior value M, to Entity B.

2. Entity A sends CPO 1's delta offset value D to Entity B.

3. Entity B applies seed string value UPID, delta offset value D, and mathematical behavior value M as input to its local TEI's to generate an “intermediate” CPP output value X.

4. Entity B sends intermediate CPP output value X as an input seed string value to Entity A.

5. Entity A applies seed string value X, delta offset value D, and mathematical behavior value M as input to its' local TEI's CPP.

6. Entity A compares the resultant CPP output value C to CPO l's stored CPP output value C (after decrypting the stored CPP output).

7. Steps 2 through 6 are performed n times, incrementing the numeric references to the CPO [1, 2, 3 . . . n] in each iteration (one iteration for each of the CPOs/C, D value pairs in the TO set).

Entity A can thus authenticate and validate the identity of Entity B's TEI based on the results of the n compare operations in step 6 above. Entity B can use these same protocol steps (substituting ‘Entity B’ for ‘Entity A’, and ‘Entity A’ for ‘Entity B’) to authenticate and validate the identity of Entity A's TEI. In addition, because the process does not use encrypted data in a Trusted Object to authenticate a TEI or entity, it may not be necessary to generate and store encrypted data in Trusted Objects.

### Numeric Reference Values that Specify Attributes About Entities

The UTM provides a general naming convention for numeric values that reference attributes about a TEI, such as the identity, ownership, and usage of the TEI.

UPID numeric values reference information to the TEI and the entity to which the TEI is attached or embedded, information such as a serial number, model number, date/time of manufacture, and manufacturer identity. UPID numerical values are applicable to all 4 Application Classes.

UTID numeric values reference information related to ownership and or usage of the TEI and the entity to which the TEI is attached or embedded. (e.g. owner: Acme Jewelers; usage: computer/Web server). These UTID numeric values are applicable to Class 2 through 4.

UGTID numeric values reference information related to identifying groups of TEIs and physical products and entities sharing common ownership and or usage (e.g. a group of Web servers sharing common Internet URL www.acmejewelers.com).

Other named numeric value references can be incorporated into a UTM infrastructure as required by the infrastructures trust and security protocols and applications.

UPID, UTID, UGTID reference numeric values may applied as input seed string values to generate Trusted Objects, CPOs, and VOs using the processes described above, when the TEI's and/or its associated physical entity is manufactured and/or when the TEI is assigned to the entity. The resulting CPOs CPP output values stored in the CPOs, seed numeric reference values (e.g. UPID), other input seed values (e.g. delta offset value D), and the encrypted data generated from them, or any combination there of, are stored and defined by the UTM as UTC TOs. UTC TOs thus relationally bind each TEI's identity, ownership, and usage information to the TEI's unique APM properties and anomalies. The UTM defines UTC TOs as the trusted root data structures from which all other CPP-bound data structures associated with the identity of each TEI, and each TEI's applicable TRs with other TEIs and physical entities, are chained throughout a TEI and its entity's life cycle. This concept of distributed relational chains of trusted data structures bound to a TEI's UTC TOs from the point(s) of manufacture and/or assigned ownership is an example of a chain-of-trust, which shall be later described. The UTM's underlying hardware and software components can be applied to other functions, applications, and data structures in addition to establishing, authenticating, validating the identities of trusted relationships between TEIs and physical entities, thus relationally binding those functions, applications, and data structures to the unique TEI and APM properties and anomalies and associated seed string, delta offset, and mathematical behavior value sources involved.

### Using Multiple CPP Values in a CPO as Multiple Keys to Encrypt a Part of a Data Structure

CPP values can be applied as cryptographic keys used in the signing, encryption and decryption of whole data structures, or parts of data structures. Examples of such parts include characters in a string or the parts of a file or message. These parts are relationally bound to the TEIs involved in generating the CPP values. The following steps are an extended version of the previous illustrative process for generating a TO which stores encrypted information signed using CPP values from the TEI bound to the TO. In this version, Entity A and its' TEI establish a Trusted Object data structure representing the identity of Entity B's TEI. With the addition of steps 14 through 17, a file is divided into subsections, and each subsection is signed/encrypted using a different symmetric cryptographic key derived from the (C, D) value pair stored in one of the CPOs.

1. Entity A assigns a numeric value as a UPID, referring to the unique identity of Entity B's TEI.

2. Entity A selects a numeric value, indicating one of the mathematical behavior functions, as mathematical behavior value M.

3. Entity A sends numeric value UPID as a seed string value, along with mathematical behavior value M, to Entity B.

4. Entity A generates and formats a random numeric value, such as the current time stamp, as delta offset value D.

5. Entity A sends delta offset value D to Entity B.

6. Entity B applies seed string value UPID, delta offset value D, and mathematical behavior value M as input to its' local TEI's CPP.

7. Entity B sends the resultant CPP output value X as a seed string value to Entity A.

8. Entity A applies seed string value X, delta offset value D, and mathematical behavior value M as input to its' local TEI's CPP.

9. The resultant CPP output value C and associated delta offset value D, numeric value UPID and mathematical behavior value M are stored in a data structure defined as a CryptoPrint Object (CPO).

10. Steps 4 through 9 are performed n times.

11. The n CPOs are linked to a stored data structure defined as a VO representing the CPOs as a set, and the set's relationship to the protocol used to establish the identity of Entity B's TEI.

12. The VO is linked to a stored data structure defined as a Trusted Object (TO) representing the identity of Entity B's TEI.

13. The numeric value UPID is stored in the TO as referring to the trusted identity of Entity B's TEI and linking that identity to an external informational data structure associated with that identity.

14. Entity A divides file F into n subsections (i.e. same number of subsections as the number of CPOs created in steps 4 through 9).

15. Entity A applies CPO l's stored CPP output value C as an input seed string value, along with delta offset value D and mathematical behavior value M, to its' local TEI's CPP

16. Entity A applies the resultant CPP output value as a symmetric cryptographic key to encrypt file F subsection 1.

17. Steps 15 and 16 are performed n times, incrementing the numeric references to the CPO and file F subsection [1, 2, 3 . . . n] by one in each iteration (one iteration for each of the CPOs/file F subsections)

Note that:

The n subsections of file F are each encrypted with a different symmetrical key that is relationally bound to the unique analog properties and anomalies of Entity A's TEI/APMs, thus securely binding file F's contents to Entity A's unique CPP-based identity.

The keys' generation is an inherent “on the fly” function of the protocol steps upon which they are based.

The keys are not stored anywhere, and are therefore inherently secure and trustworthy.

The following steps allow Entity A to subsequently decrypt the subsections of file F:

1. Entity A applies CPO l's stored CPP output value C as an input seed string value, along with delta offset value D and mathematical behavior value M, to its' local TEI's CPP.

2. Entity A applies the resultant CPP output value as a symmetric cryptographic key to decrypt file F subsection 1.

3. Steps 1 and 2 are performed n times, incrementing the numeric references to the CPO and file F subsection [1, 2, 3 . . . n] by one in each iteration (one iteration for each of the CPOs and file F subsections).

The above method of generating cryptographic keys can be seen to have significant advantages over methods that require keys to be generated and maintained through disassociated processes, that require the numeric key values to be securely stored and hidden or protected, and that do not establish a bound trusted relationship between the keys and the physical identities of entities authorized to use those keys. Regardless of the key sizes or complexity of the algorithms or protocols applied, the level of security provided by cryptographic methods based on stored numeric key values is no better than the ability of the keys' intended holders or users to hide and protect the keys from unauthorized access.

The above method of generating cryptographic keys authenticates and validates the keys' holders and users, and bounds the keys to their CPP-based identity. The rightful holder or user can be deemed as authenticated and validated by its' ability to successfully decrypt the data encrypted by the key. The above method therefore has significant advantages over other methods of cryptographically protecting and authenticating validating identification data structures, such as digital ID certificates, which rely on stored and hidden numeric key values.

There are many other possible protocols, methods and approaches to leveraging the UTM's hardware and software components in providing trusted and secure storage and communications channels. Details of the relationally bound data communications concept are covered in the '457.

The UTM's object-oriented approach to trust and security allows any and all data structures associated with the application and use of TRs existing between physical entities, such as access authorization, application code, and usage rights, to be relationally bound to those entity's trusted CPP-based identities using such cryptographic storage and communications channel protocols, methods and approaches.

In the previous example protocols, the input seed string, delta offset and mathematical behavior value's source was limited to a single TEI for illustrative simplicity. In practice, however, input values can come from different sources, and/or the paths can be divided into multiple logical segments, with different sources for each segment's input. For example, a TEI/APM with a physical input seed string path 1024 bits wide can be defined as having 8 128-bit seed string inputs.

Each of a TEI/APM's output values can thus be relationally bound to the confluence of a specific combination of input seed string, delta offset and/or mathematical behavior values and sources, and to the CPP-based identities of those sources. This concept allows establishing, authenticating, and validating highly complex and secure distributed dynamic relational trust associations between TEIs and physical entities.

### Trust Infrastructure Elements

The UTM encompasses a number of other concepts and elements that provide the building blocks for creating security infrastructures that let many parties authenticate a set of Trusted Entities. These include, without limitation, the following.

A Trusted Object Domain (TOD) is a distributed system of trusted processing entities (e.g. computers, cell phones, handheld PDAs, card readers) that establish Trusted Entities or that can authenticate a Trusted Entity established by one or more trusted processing entities within the system. TOs are created by one or more trusted processing entities within the TOD to establish Trusted Entities and relationships. The storage of the TO and related data structures is distributed among the trusted processing entities in a TOD. Details of an example of a Trusted Object Domain are covered in the '221 and UTM Application.

The Trusted Object Naming Service (TONS) server is a trusted data processing entity that acts as trusted repository, registration authority, directory and validation service provider within a TOD for TOs, associated TO numeric reference values (UTCs, UPIDs, UTIDs, and UGTIDs), and the associated physical Trusted Entities within the TOD. TONS servers are themselves Trusted Entities, and thus must contain one or more TEIs to bind each TONS server to the relational chain-of-trust structure within the TOD they are part of, to ensure and control authorized usage. TONS and TOMA services are Class 4 applications.

The Trusted Object Management Agent (TOMA) is a trusted data processing entity within a TOD that may establish a Trusted Entity, and thus create TOs that are stored on a TONS server. TOMAs are capable of authenticating a Trusted Entity. TOMAs are Trusted Entities, and must contain one or more TEIs that bind the TOMA to a relational chain-of trust structure within the TOD they are part of, to ensure and control authorized usage. TOMAs can be dedicated devices and entities specifically designed for TO management functions, or devices and entities that also serve other functions. TONS servers are generally also TOMAs.

The Trusted Objects Reference Agent (TORA) can authenticate and validate Trusted Entities using TOs that are stored on a TONS server. TORAs thus serve as read-only versions of TOMAs. TORA services are Class 3 applications.

Each trusted processing entity has a trusted relationship or chain-of-trust relationship with other trusted processing entities in the domain. A chain-of-trust is a series of Trusted Entities linked together by trusted relationships, where each Trusted Entity or TOD has a trusted relationship with an adjacent member in the series. An entity is referred to as having a chain-of-trust relationship with another when a chain-of-trust can be authenticated and verified to exist between them. A chain-of-trust cannot be created unless every entity is authentic. Thus, a particular TEI can be authenticated by another TEI if the other TEI may form a chain-of-trust with the particular TEI. Trusted entities that can be linked together in a chain-of-trust are referred to as having a chain-of-trust relationship.

The TONS directory naming schema can be used to identify chains-of-trust and Trusted Entities using sequences of alphanumeric strings prefixed by symbolic representations representing types of Trusted Entities. Specifically, the symbol “!” is used for TOMAs, “˜” for TORAs, and “+” for Trusted Entities that are not designated or authorized trust administration agents, and “.” for products or entities that are not themselves Trusted Entities but are associated with a Trusted Entity, such as a product contained in a physical package, where a TEI is attached to the container but not the product.

For example, the string !acmewidgets˜checkpoint29+container384.widget57619 is used to designate a chain-of-trust between a non-Trusted Entity product, the Trusted Entity container used to package the product, a TORA authenticating and validating the product containers' identity, and the TOMA/TONS server for the TORA's TOD. The string container384 references the container's UPID, checkpoint29 references the TORA's UTID, and acmewidgets references Acme Widgets' TOD's TOMA/TONS server's UTID. The string widget576192 has no direct referential meaning in the context of a UTC, but serves as an associative reference to the UPID of the container in which the product is packaged.

TONS servers can function as trusted audit references in resolving transaction repudiation disputes. This capability involves having a TONS server time-stamp, log and archive, in CPP-based encrypted file systems, records of every TO and TR activity it arbitrates.

### Address Space of TEI Input Seed String Values

The range of possible input seed string values supported by a given TEI implementation (where range refers to the span of all numeric values from 0 to the maximum value accepted as input by a TEI) can be very large. For example, an input seed string path that is 1024 bits wide equates to a range of values that is approximately 1.8 followed by 308 zeros (decimal). This range is referred to as a TEI's input seed string “address space”.

This very large address space allows TEI application protocols to be defined and implemented in which the set of seed string values associated with generating cryptographic keys used to encrypt and decrypt data stored within TOs, and to secure communication channels between TEIs, is different for each TO or communicated data segment, and is constantly changing in the context of each TEI's usage and application.

An example of such a protocol might define a contiguous sequential ordering of input seed string values, starting from the value assigned to each TEI's UPID, and thereafter throughout each TEI's lifecycle. Using this protocol, for a UPI) value of 10000, the first five input seed string values applied to the TEI associated with that UPID would be 10000, 10001, 10002, 10003, and 10004. Note that the resulting five CPP output values produced by that TEI, and all of the TEI's subsequent CPP output values, would be totally random in order, since the TEI's internal CPP processes are such that there is no inherent mathematical correlation between any of the output values produced by the TEI. The use of a sequential input seed string order, or any other ordering technique, therefore, reveals nothing to an attacker about what the TEI's resultant CPP output values will be or the numeric order those values will be in.

Each cryptographic key generated using this concept is thus confined to the specific input seed string values (addresses) associated with it as compared to the far larger total address space of one or more TEIs. Consequently, the value of a given cryptographic key that is generated based on CPP output values resulting from the input of seed values to one or more TEIs reveals nothing about the value of any other cryptographic key generated following the same methodology using a different set of input seed string values.

Further examples of the distributed relational chain-of-trust concept are covered in the Chains-of-Trust.

### Kernel Trust Architecture

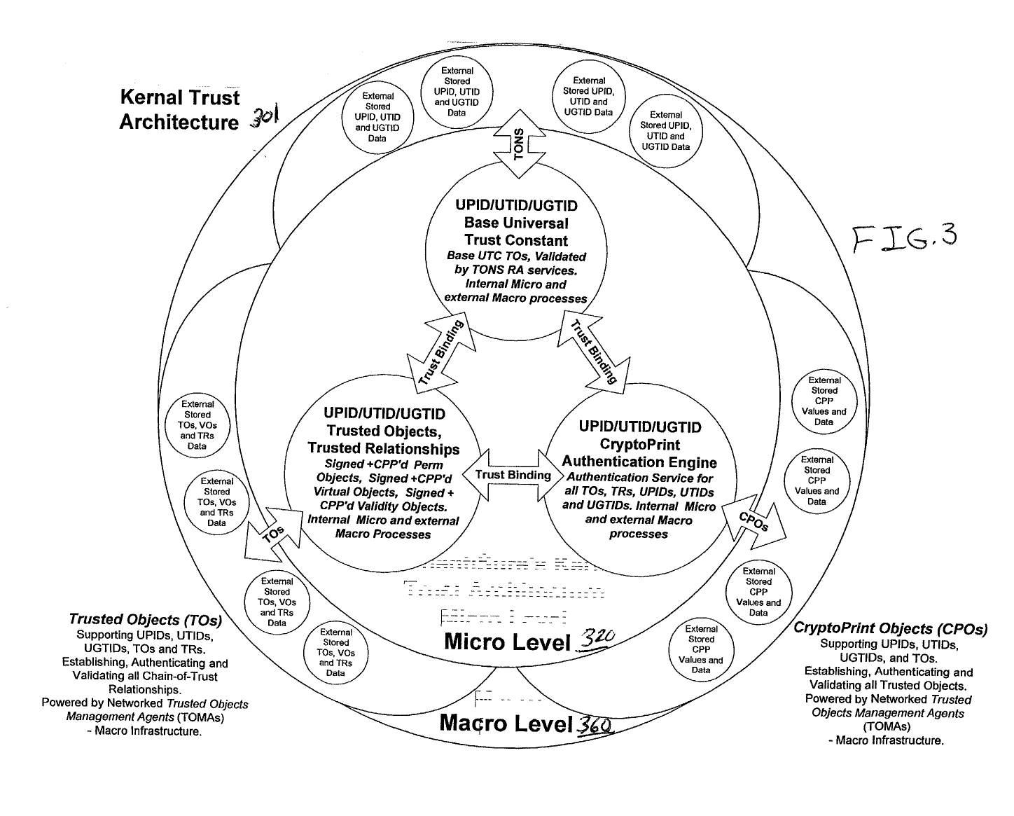

Referring to FIG. 3, the Kernel Trust Architecture 301 defines TOD hardware and software components and services that can be used to support:

Establishing, authenticating and validating the CPP-based identities of TEIs and physical entities.

Binding those identities to other data structures associated with the TEIs and physical entities' application and usage.

Establishing, authenticating, validating and transferring chain-of-trust relationships between TEIs and physical entities.

Establishing, authenticating and validating CPP-bound TRs between TODs.

The Kernel Trust Architecture divides these hardware and software components and services into two infrastructure levels, micro level 320 and macro level 360. The micro level 320 infrastructure refers to hardware and software components and services supporting the UTM's trust and security capabilities that exist internally within TEI IC chips. The macro level 360 infrastructure refers to hardware and software components and services supporting the UTM's trust and security capabilities, and that exist externally from TEI IC chips (i.e. TONS and TOMA/TORA servers).

The Kernel Trust Architecture defines three groups of macro infrastructure hardware and software components and services:

CPOs that incorporate UPIDs, UTIDs, UGTIDs, and provide the base data structures for establishing, authenticating and validating trusted entities through networked TOMAs and TORAs.

Trusted entities that support UPIDs, UTIDs, UGTIDs, TOs, and TRs, and provide the base structures for establishing, authenticating and validating all chain-of-trust relationships through networked TOMAs and TORAs.

TONS Registration Authority (RA) and Validation Authority (VA) servers, which support UTCs, act as repositories and validation authorities for trusted entities, provide naming directory services for CPO/VO/TO data structures, and provide identification and validation of TOMA and TORA servers.

The Kernel Trust Architecture defines three groups of micro infrastructure hardware and software components and services:

The UPID/UTID/UGTID CryptoPrint Authentication Engine which, through internal micro and external macro processes, provides the CPP-based authentication service for all TOs, TRs, UPIDs, UTIDs, and UGTIDs

The UPID/UTID/UGTID TOs and TRs which, through internal and external processes, provide CPP-based signing of permanent (UTC) TOs, virtual TOs, and VOs.

The UPID/UTID/UGTID based UTCs which, through internal micro and external macro processes, provide the ability to establish and archive base UTC TOs in TONS servers.

Details of the Kernel Trust Architecture concept are covered in '298.

### Example Root Data Structures for a UTM Implementation

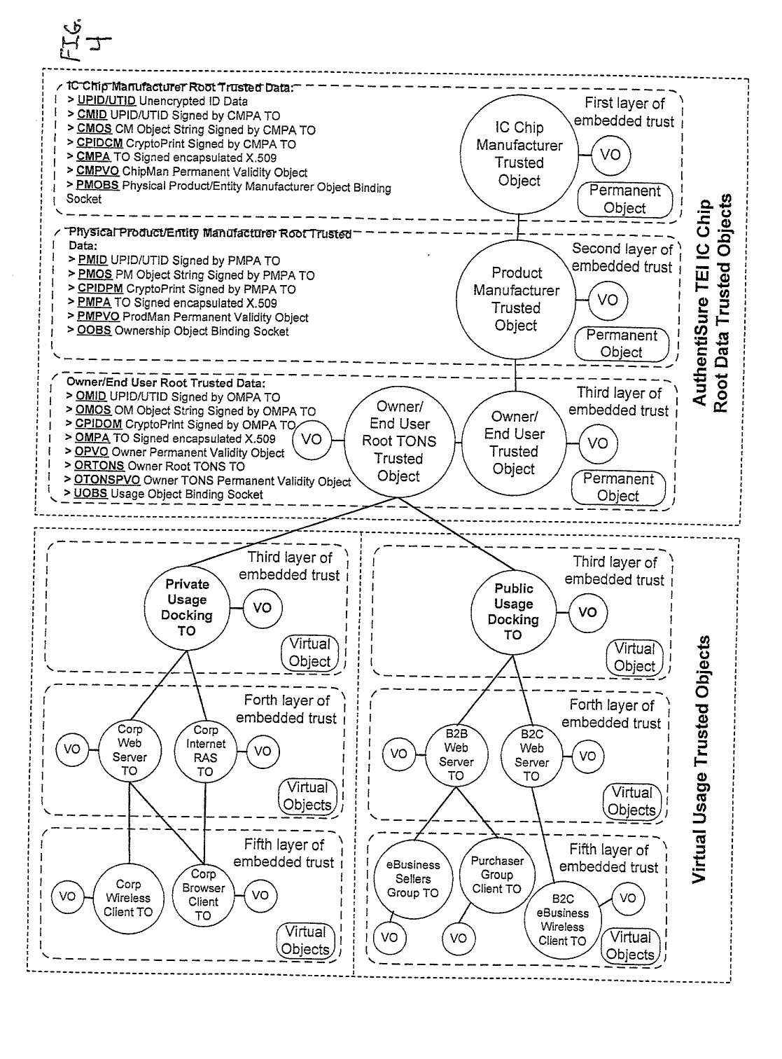

Referring to FIG. 4, a block diagram showing an example UTM implementation based on four permanent UTC (root data) TOs and a number of private/public applications' virtual usage TOs is shown. This implementation illustrates how the roles of establishing, authenticating, and validating various attributes of a TEI can be distributed among several trusted parties involved in the ThI/entity's manufacture, usage and application, and how many different informational elements, both unencrypted and encrypted, can be securely encapsulated within TO data structures.

A first layer of embedded trust is established/authenticated and validated by the IC Chip Manufacturer TO, which binds the identity of a TEI IC chip to the trusted identity of the IC chip's manufacturer. The root trusted data associated with the IC Chip Manufacturer TO includes:

The UPID/UTID identification values associated with the TEI IC chip

Encrypted Chip Manufacturer Identification (CMID) data, which are UPID/UTID values signed by the Chip Manufacturer Product Authority (CMPA) TO representing the IC chip manufacturer's trusted identity.

Encrypted Chip Manufacturer Object String (CMOS) data, which is a CM object trust string signed by the CMPA TO. A CM object trust string represents the chain-of-trust relationship between the TEI/entity's UPID, the chip manufacturing facility's TOD, and any TODs which the manufacturing facility's TOD is a subset member of. For example, !man!chipman!acmesemiconductor!plant3+UPID describes the chain-of-trust relationships which includes the TEI's UPID to Plant 3's TOD, Plant 3's TOD to and as a member of Acme Semiconductor's TOD, Acme Semiconductor's TOD to and as a member of the ChipMan TOD (a conglomerate of IC chip manufacturers), and the ChipMan TOD to and as a member of the Man TOD (a conglomerate of manufacturing industries).

Encrypted CryptoPrint Identification Chip Manufacturer (CPIDCM) data, which are TEI IC chip CPP output values signed by the CMPA Trusted Entity.

Encrypted CMPA TO data, which is an X.509 digital certificate associated with the IC chip manufacturer's identity, encapsulated within a signed TO data structure.

CMPVO data, which is the permanent VO associated with the CMPA trusted entity.

Product Manufacturer Object Binding Socket (PMOBS) data, which provides a socket for binding the IC Chip Manufacturer TO to the associated Product Manufacturer TO in the second layer of embedded trust.

The second layer of embedded trust is established, authenticated and validated by the Product Manufacturer TO, which binds the identity of a physical entity and its' associated TEI IC chip to the trusted identity of the entity's manufacturer. The root trusted data associated with the Product Manufacturer TO includes:

Encrypted Product Manufacturer Identification (PMID) data, which are UPID/UTID values signed by the Product Manufacturer Product Authority (PMPA) TO representing the entity manufacturer's trusted identity.

Encrypted Product Manufacturer Object String (PMOS) data, which is a PM object trust string signed by the PMPA TO. A PM object trust string represents the chain-of trust relationship between the TEl/ entity's UPID, the entity manufacturing facility's TOD, and any TODs which the manufacturing facility's TOD is a subset member of. For example, !man!prodman!gelco!plant12+UPID describes the chain-of-trust relationship of a TEI/procuct/entity's UPID to Plant 12's TOD, Plant 12's TOD to and as a member of Gelco's TOD, Gelco's TOD to and as a member of the ProdMan TOD (a conglomerate of product manufacturers), and the ProdMan TOD to and as a member of the Man TOD (a conglomerate of manufacturing industries).

Encrypted CryptoPrint Identification Product Manufacturer (CPIDPM) data, which are TEI IC chip CPP output values signed by the PMPA trusted entity.

Encrypted PMPA TO data, which is an X.509 digital certificate associated with the IC chip manufacturer's identity, encapsulated within a signed TO data structure.

PMPVO data, which is the permanent VO associated with the PMPA TO.

Ownership Object Binding Socket (OOBS) data, which provides a socket for binding the Product Manufacturer TO to the associated Owner/End User TO in the third layer of embedded trust.

The third layer of embedded trust is established, authenticated, and validated by the Owner/End User TO and Owner/End User Root TONS TO, which binds the identity of a physical entity and its' associated TEI IC chip to the trusted identity of the entity's owner, and to the Trusted Object Naming Service (TONS) associated with the owner's TOD. The root trusted data associated with the Owner/End User TO and Owner/End User Root TONS TO includes:

Encrypted Owner/End User Identification (OMID) data, which are UPIDIUTID values signed by the Owner/End User Product Authority (OMPA) TO representing the entity owner's trusted identity.

Encrypted Owner/End User Object String (OMOS) data, which is an OM object trust string signed by the OMPA TO. An OM object trust string represents the chain-of-trust relationship between the TEl/ entity's UPID, the entity owner facility's TOD, and any TODs which the owner facility's TOD is a subset member of. For example, !ser!isp!compucom!intemnet+UPID describes the chain-of-trust relationship of a TEI/entity's UPID to the (Compucom) Internet TOD, the Internet's TOD to and as a member of Compucom's TOD, Compucom's TOD to and as a member of the ISP TOD (a conglomerate of Internet Service Providers), and the ISP TOD to and as a member of the Ser TOD (a conglomerate of service providers).

Encrypted CryptoPrint Identification Product Manufacturer (CPIDOM) data, which are TEI IC chip CPP output values signed by the OMPA TO.

Encrypted OMPA TO data, which is an X.509 digital certificate associated with the owner's identity, encapsulated within a signed TO data structure.

OPVO data, which is the VO associated with the OMPA TO.

ORTONS data, which is the owner Root TONS TO.

OTONSPVO data, which is the owner TONS permanent VO.

Usage Object Binding Socket (UOBS) data, which provides a socket for binding the Owner/End user Root TONS TO to the associated Private Usage Docking TO and/or Public Usage Docking TO in the third layer of embedded trust.

The Private Usage Docking TO and Public Usage Docking TO provide chain-of-trust object linkages between the TEI/entity's permanent UTC TOs and the virtual TOs associated with private/public network applications, some examples of which are shown.

### Private UTM Implementation

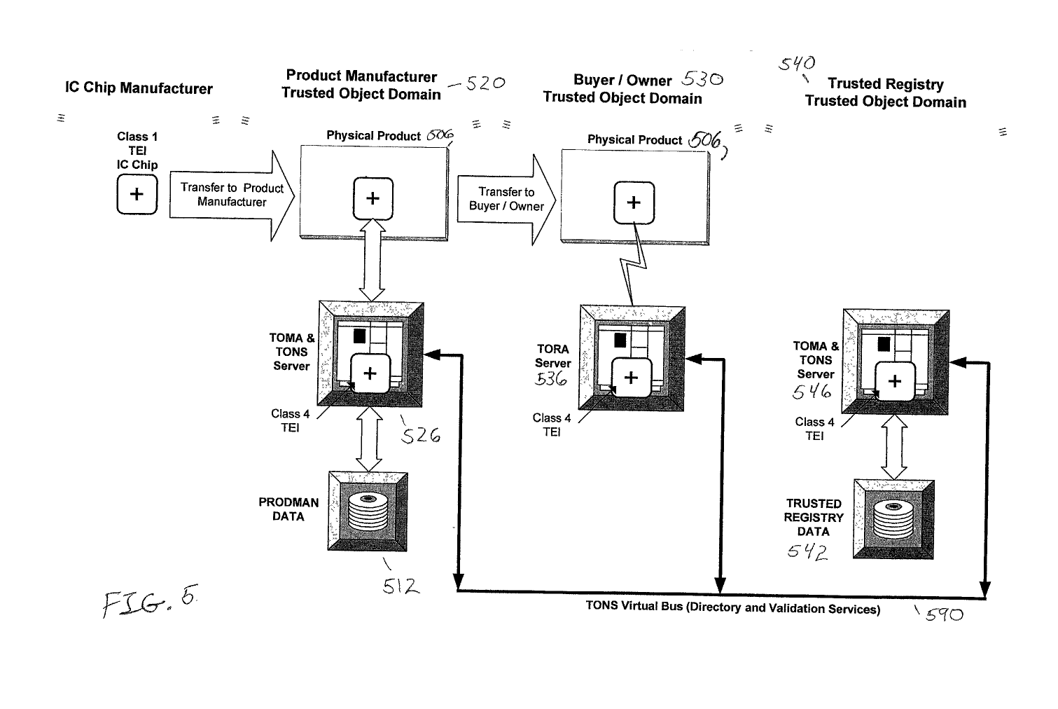

Referring to FIG. 5 is a block diagram of an example closed (private) UTM implementation. The application's basic trust and security requirements are:

Class 1 TEI IC chips are to be supplied to a Product Manufacturer by an IC Chip Manufacturer. The IC Chip Manufacturer does not support any UTM infrastructure or services.

Each of the Physical Products produced by the Product Manufacturer is to have one Class 1 TEI IC chip embedded within it. The Product Manufacturer supports its' own TOD infrastructure, which consists of a single data processing system providing both TOMA and TONS services.

The Physical Products' Buyer or Owner is to supply the Product Manufacturer with per-product ownership information for each Physical Product purchased. The Buyer and/or Owner supports its' own TOD infrastructure, which consists of a single data processing entity providing TORA functions.

All trusted data pertaining to a particular TEI IC chip and its' associated Physical Product is to be established by the Product Manufacturer via a direct connection to the chip at the time the chip is embedded within the product.

The reading and authentication and validation of trusted data pertaining to each TEI IC chip and its' associated Physical Product is to be allowed by the product's Buyer or Owner via a wireless communications link to the chip.

A separate Trusted Registry TOD providing TONS directory and validation services related to the identities and status of the TEI IC chips and physical entities. The Product Manufacturer's TOD and the Buyer or Owner's TOD is established and made available to the Product Manufacturer and the Buyer or Owner in support of the application's trust and security requirements. The Trusted Registry TOD consists of a single data processing system providing both TOMA and TONS server functions and services.

In this UTM implementation, two sets of UTCs are established for each TEI embedded product sold to the Buyer or Owner. The first set is established and stored and referenced by the Product Manufacturer TOD TOMA & TONS server 526 and PRODMAN DATA store 512, and is relationally bound to that server's CPP-based identity. The second set is established, stored, and referenced by the Trusted Registry TOD TOMA & TONS server 546 and TRUSTED REGISTRY DATA store, via the Product Manufacturer TOD TOMA & TONS server 526, and is relationally bound to that server's CPP-based identity. The Buyer or Owner TOD TORA 536 can thus reference and authenticate and validate each TEI IC chip UPID and associated informational data structure/file in either the Trusted Registry TOD 540, the Product Manufacturer TOD 520, or both, via the TONS Virtual Bus 590.

The basic steps required to establish and register a TEI IC Chip and Physical Product as a TO are:

The Buyer or Owner TOD TORA 536 server initiates a connection to the Product Manufacturer TOD TOMA & TONS server 526.

The Buyer or Owner TOD TORA 536 server, Product Manufacturer TOD 520 TOMA & TONS server, and Trusted Registry TOD TOMA & TONS server 546 authenticate and validate each others' trusted identity and status via the Trusted Registry TOD TOMA & TONS server 546's TRUSTED REGISTRY DATA store.

The Product Manufacturer receives purchase and ownership information from the Buyer or Owner for a physical product to be manufactured.

The Product Manufacturer selects a Class 1 TEI IC chip, previously received from the IC Chip Manufacturer, to be embedded into the target Physical Product.

The Product Manufacturer TOD TOMA & TONS server 526 assigns a unique UPID value to the TEI IC chip and Physical Product and the associated TEI IC chip and Physical Product informational data structures.

The Product Manufacturer TOD TOMA & TONS server 526 connects to the Class 1 TEI IC chip and establishes a UTC based on the product's assigned UPiD numeric value.

The Product Manufacturer TOD TOMA & TONS Server 526 stores the chip and product's UTC in PRODMAN DATA 512.

The Product Manufacturer TOD TOMA & TONS Server 526 forwards copies of the UPID and informational data structure and file associated with the chip and product to the Trusted Registry TOD TOMA & TONS server 546 to initiate directory registration.

The Trusted Registry TOD TOMA & TONS server 546 connects to the Class 1 TEI IC chip 303, via the Product Manufacturer TOD TOMA & TONS server 526, and establishes a UTC based on the chip and product's assigned UPID numeric value.

The Trusted Registry TOD TOMA & TONS server 546 stores the chip and product's UTC and associated informational data structure in TRUSTED REGISTRY DATA 542.

The basic steps required for the Buyer or Owner TOD TORA 536 server to authenticate and validate a TEI IC chip and product identity via the Trusted Registry TOD TOMA & TONS server 546 are:

The Buyer or Owner TOD TORA 536 server initiates a connection to the Trusted Registry TOD TOMA & TONS server 546.

The Buyer or Owner TOD TORA 536 server and Trusted Registry TOD TOMA & TONS server 546 authenticate and validate each others' trusted identity and status via the Trusted Registry TOD TOMA & TONS server TRUSTED REGISTRY DATA store 546.

The Buyer or Owner TOD TORA 536 server requests TEI IC chip and product identity authentication and validation from the Trusted Registry TOD TOMA & TONS server 546.

The Trusted Registry TOD TOMA & TONS server 546 connects to the Physical Product's TEI IC Chip, via the Buyer or Owner TOD TORA Server 536, and authenticates and validates the TEI IC chip and Physical Product's identity by referencing the UTC associated with the chip and product's UPID as previously stored in TRUSTED REGISTRY DATA.

### Public/Private Implementation of UTM

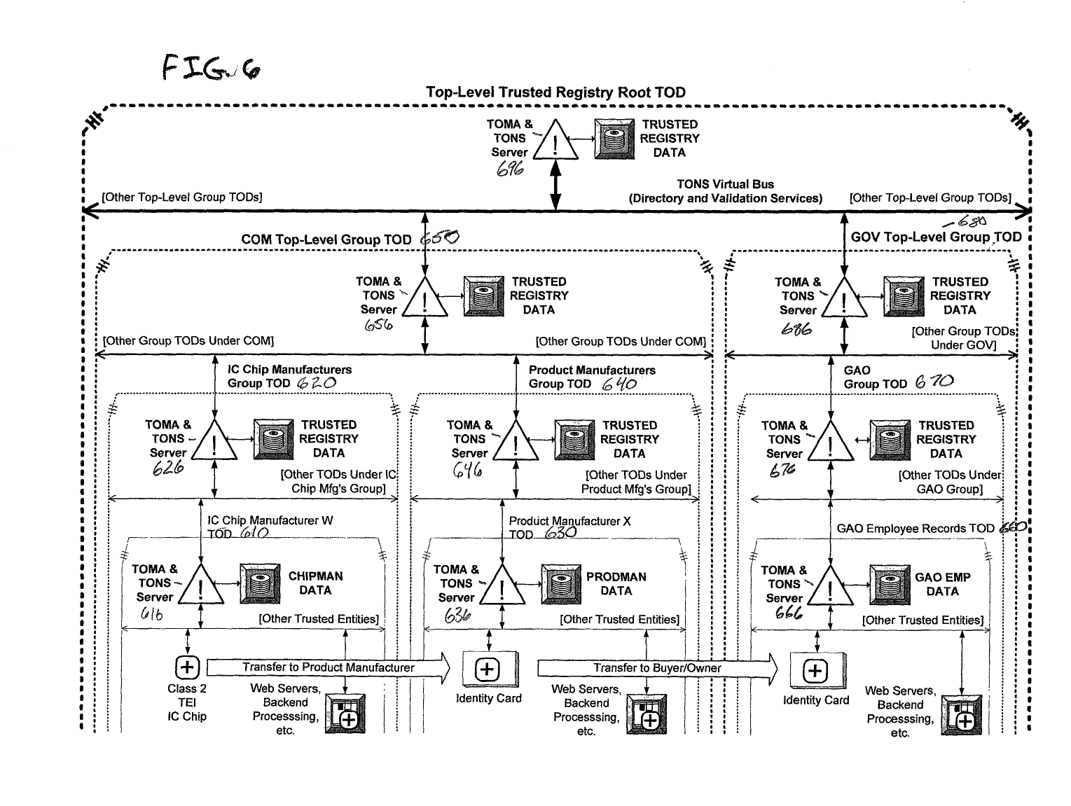

FIG. 6 is a diagram of an example hybrid (public/private) UTM implementation. The a application's basic trust and security requirements are: Class 2 TEI IC chips are to be supplied to Product Manufacturer X by IC Chip Manufacturer W. IC Chip Manufacturer W supports its' own TOD infrastructure, which consists of a data processing system providing both TOMA and TONS server functions and services, as well as a number of other data processing systems and entities. IC Chip Manufacturer W is to supply per-chip identity and manufacturing information, and to assign and establish a unique UPID and associated UTC in its' local TONS registry at the time of the chip's manufacture.

Referring to FIG. 6:

The IC Chip Manufacturer W TOD 610 is a subset member of the IC Chip Manufacturers Group TOD 620, which authenticates and validates the identities of and trusted relationships between its' member TODs.

Each of the Identity Cards produced by Product Manufacturer X is to have one Class 2 TEI IC chip embedded within it. Product Manufacturer X supports its' own TOD infrastructure, which consists of a data processing system providing both TOMA and TONS server functions and services, as well as a number of other data processing systems and entities. Product Manufacturer X is to supply per-card identity and manufacturing information, and to establish a UTC associated with the chip and card's UPID, as previously assigned by the chip's manufacturer, in its' local TONS registry at the time the chip is embedded within the card.

The Product Manufacturer X TOD 630 is a subset member of the Product Manufacturers Group TOD 640, which authenticates and validates the identities of and trusted relationships between its' member TODs.

The IC Chip Manufacturers Group TOD 620 and Product Manufacturers Group TOD 640 are subset members of the COM Top-Level Group TOD 650, which authenticates and validates the identities of and trusted relationships between its' member Group TODs.

The Identity Cards' Buyer or Owner (GAO Employee Records) is to supply per-card ownership and usage information for each Identity Card purchased, and to assign and establish a unique UTID and associated UTC data structure set in its' local TONS registry at the time the card is issued to its' holder or user. GAO Employee Records supports its' own TOD infrastructure, which consists of a data processing entity providing both TOMA and TONS server functions and services, as well as a number of other data processing systems and entities.

The GAO Employee Records TOD 660 is a subset member of the GAO Group TOD 670, which authenticates and validates the identities of and trusted relationships between its' member TODs.

The GAO Group TOD 670 is a subset member of the GOV Top-Level Group TOD 680, which authenticates and validates the identities of and trusted relationships between its' member Group TODs.

The COM Top-Level Group TOD 650 and GOV Top-Level Group TOD 680 are subset members of the Top-Level Trusted Registry Root TOD 690, which authenticates and validates the identities of and trusted relationships between its' member Top-Level Group TODs.

In this UTM implementation, a number of private TODs (IC Chip Manufacturer W, Product Manufacturer X, and GAO Employee Records) are registered as subgroup members of public TODs. These public TODs serve as trust references for establishing, authenticating, validating the identities of and trusted relationships between their subgroup member TODs, and for establishing, authenticating, and validating the identities of and trusted relationships between their subgroup member TODs and other associated TODs.

For example, a chain-of-trust relationship between the IC Chip Manufacturer W TOD TOMA & TONS server 616 and the Product Manufacturer X TOD TOMA & TONS server 636 could be expressed as !chipmanW!chipmangrp!com!prodmangrp!prodmanX. The IC Chip Manufacturer W TOD TOMA & TONS server 616 is authenticated and validated by the IC Chip Manufacturers Group TOD TOMA & TONS server 626, which is authenticated and validated by the COM Top-Level Group TOD TOMA & TONS server 656, which also authenticates and validates the Product Manufacturers Group TOD TOMA & TONS server 646, which authenticates and validates the Product Manufacturer X TOD TOMA & TONS server 636. The highest level of explicit trust in this example is therefore the COM Top-Level Group TOD TOMA & TONS server 656; the Top-Level Trusted Registry Root TOD TOMA & TONS server 696 is implicit as authenticating and validating the COM Top-Level Group TOD TOMA & TONS server 656.

In another example, a chain-of-trust relationship between the Product Manufacturer X Web server and the GAO Employee Records Web server could be expressed as +www!prodmanX/prodmangrp!com!gov!gao!gaoemp+www (the infrastructures' Top-Level Trusted Registry Root TOMA & TONS server always authenticates and validates the trust relationships between Top-Level Group TODs and therefore does not have to be included between com and gov in the chain-of-trust expression string). The Product Manufacturer X Web server is authenticated and validated by the Product Manufacturer X TOD TOMA & TONS server 636, which is authenticated and validated by the Product Manufacturers Group TOD TOMA & TONS server 646, which is authenticated and validated by the COM Top-Level Group TOD TOMA & TONS server 656, which is authenticated and validated by the Top-Level Trusted Registry Root TOD TOMA & TONS server 696, which also authenticates and validates the GOV Top-Level Group TOD TOMA & TONS server 686, which authenticates and validates the GAO Group TOD TOMA & TONS server 676, which authenticates and validates the GAO Employee Records TOD TOMA & TONS server 666, which authenticates and validates the GAO Employee Records Web server. The highest level of explicit trust in this example is therefore the Top-Level Trusted Registry Root TOD 690.

This hybrid (public/private) UTM implementations' hierarchical trust structure allows different levels of trust to be delegated, established and maintained by different agencies and entities. The Top-Level Trusted Registry Root TOD 690 could be established and maintained by an entity representing and appointed by a governmental body, similar to the Internet's ICANN top-level domain naming authority. The Top-Level Group TODs, in turn, could be established and maintained by one or more agencies and entities approved and overseen by the Root TODs' administrative body, etc. UTM member agencies and entities at lower infrastructure levels could thus establish and maintain private, self-administered TOD structures and substructures that leverage and share the uniformity and organizational trust and security provided by the higher public infrastructure levels, with all of the infrastructure members', components', elements' trust and security logically and virtually bound to their chain-of-trust relationships.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method used for encryption, the method comprising the steps of:
receiving a first digital input from a set of possible digital inputs;
wherein each digital input in said set of possible digital inputs causes a first integrated circuit to generate a corresponding unique output value;
generating a first output value based on applying said first digital input to said first integrated circuit; and
generating a first encryption key based on the first output value.

2. The method of claim 1, wherein the step of generating a first output value is based on anomalies of said first integrated circuit.

3. The method of claim 2, wherein said anomalies are either inherit or intentionally induced.

4. The method of claim 1, wherein:
the steps further include generating a second output value based on applying a second digital input from a second integrated circuit; and
the step of generating a first encryption key based on the first output value includes generating a first encryption key based the first output value and the second output value.

5. The method of claim 4, wherein said second digital input is generated based on said first output value.

6. The method of claim 1, wherein the steps further include generating a data structure that includes encrypted data encrypted using said first encryption key.

7. The method of claim 6, wherein the steps further include:
causing said first digital input to be stored in persistent storage;
causing said first digital input to be retrieved from said persistent storage;
regenerating said first output value by causing said first digital input to be applied to said first integrated circuit;
regenerating said first encryption key based on said first output value; and
decrypting said encrypted data using said first encryption key.

8. The method of claim 4, wherein the steps further include
generating a data structure that includes encrypted data encrypted using said first encryption key.

9. The method of claim 8, wherein the steps further include:
causing said first digital input to be stored in persistent storage;
causing said first digital input to be retrieved from said persistent storage;
causing said first digital input to be applied to said first integrated circuit to generate said first output value;
regenerating said second digital input based on said first digital input;
regenerating said second output value by applying said second digital input to said second integrated circuit;
regenerating said first encryption key based on the second output value; and
decrypting said encrypted data using said first encryption key.

10. The method of claim 1, wherein the steps further include:
generating a first data structure that contains first data and encrypted first data, wherein said encrypted first data is an encrypted version of said first data encrypted using said first encryption key;
causing to be stored in persistent storage: a second data structure that specifies said first digital input, and linking data that associates said first data and said second data structure.

11. The method of claim 10, wherein the steps further include
receiving said first data;
examining said linking data to retrieve said second data structure;
generating said first digital input based on said second data structure;
regenerating said first output value based on applying said first digital input to said first integrated circuit;
regenerating said first encryption key based on the regenerated first output value; and
decrypting said encrypted first data using said first encryption key.

12. The method of claim 10, wherein said first data comprises an identifier value that identifies an attribute associated with said first integrated circuit.

13. The method of claim 12, wherein said identifier value specifies the identity of an entity into which the first integrated circuit has been incorporated.

14. The method of claim 12, wherein said identifier value specifies the ownership of an entity into which the first integrated circuit has been incorporated.

15. A device, the device comprising
a digital input mechanism that applies a first digital input from a set of possible digital inputs, wherein each digital input of said set of possible digital inputs causes an integrated circuit to generate a corresponding unique output value;
an output value detection mechanism that detects a first output value generated based on applying said first digital input to said first integrated circuit; and
a key generation mechanism that generates a first encryption key based on the first output value.

16. The device of claim 15, wherein said output value detection mechanism detects said first output values based on anomalies of said integrated circuit.

17. The device of claim 15, wherein said anomalies are inherent or intentionally induced.

18. A device, the device comprising
means for applying a first digital input from a set of possible digital inputs, wherein each digital input of said set of possible digital inputs causes an integrated circuit to generate a corresponding unique output value;
means for detecting a first output value generated based on applying said first digital input to said first integrated circuit; and
a key generation mechanism that generates a first encryption key based on the first output value.

19. The device of claim 18, wherein said output value detection mechanism detects said first output value based on anomalies of said integrated circuit.

20. The device of claim 18, wherein said anomalies are inherent or intentionally induced.

21. A computer-readable medium carrying one or more sequences of instructions for encryption of information, wherein execution of the one or more sequences of instructions by one or more processors causes the one or more processors to perform the steps of:
receiving a first digital input from a set of possible digital inputs;
wherein each digital input in said set of possible digital inputs causes a first integrated circuit to generate a corresponding unique output value;
generating a first output value based on applying said first digital input to said first integrated circuit; and
generating a first encryption key based on the first output value.

22. The method of claim 1, wherein the step of generating a first output value is based on anomalies of said first integrated circuit.

23. The method of claim 2, wherein said anomalies are either inherit or intentionally induced.
